(19) United States
(12) Patent Application Publication
(10) Pub. No.: US 2007/0062194 A1
(43) Pub. Date: Mar. 22, 2007

(54) Renewable energy credits

(76) Inventor: Eric Ingersoll, Cambridge, MA (US)

Correspondence Address: HELLER EHRMAN LLP, 275 MIDDLEFIELD ROAD, MENLO PARK, CA, 94025-3506, US

(21) Appl. No.: 11/437,407

(22) Filed: May 19, 2006

Related U.S. Application Data
(63) Continuation-in-part of application No. 10/744,232, filed on Dec. 22, 2003.

(51) Int. Cl. F03G 7/00; F01K 27/00

(52) U.S. Cl. 60/641.1

(57) ABSTRACT

A method is provided for creating renewable energy credits from a wind energy system. A wind energy system is provided with a plurality of direct compression wind turbine stations. Direct compression is direct rotational motion of a shaft or a rotor coupled to one or more compressors. Wind energy is collected and stored from the plurality of direct compression wind turbine stations. Storage of the wind energy and the thermal energy system are used to create renewable energy credits.

### RELATED APPLICATIONS

This application is a continuation-in-part of U.S. Ser. No. 10/744,232, filed Dec. 22, 2003, which application is fully incorporated herein by reference.

### BACKGROUND

1. Field of the Invention

This invention relates generally to methods for creating renewable energy credits from a wind energy system, and more particularly creating renewable energy credits with wind energy system that has a plurality of direct compression wind turbine stations.

2. Description of the Related Art

From its commercial beginnings more than twenty years ago, wind energy has achieved rapid growth as a technology for the generation of electricity. The current generation of wind technology is considered mature enough by many of the world's largest economies to allow development of significant electrical power generation. By the end of 2005 more than 59,000 MW of windpower capacity had been installed worldwide, with annual industry growth rates of greater than 25% experienced during the last five years.

Certain constraints to the widespread growth of windpower have been identified. Many of these impediments relate to the fact that in many cases, the greatest wind resources are located far from the major urban or industrial load centers. This means the electrical energy harvested from the areas of abundant wind must be transmitted to areas of great demand, often requiring the transmission of power over long distances.

Transmission and market access constraints can significantly affect the cost of wind energy. Varying and relatively unpredictable wind speeds affect the hour to hour output of wind plants, and thus the ability of power aggregators to purchase wind power, such that costly and/or burdensome requirements can be imposed upon the deliverer of such varying energy. Congestion costs are the costs imposed on generators and customers to reflect the economic realities of congested power lines or “Bottlenecks.” Additionally, interconnection costs based upon peak usage are spread over relatively fewer kwhs from intermittent technologies such as windpower as compared to other technologies.

Power from existing and proposed offshore windplants is usually delivered to the onshore loads after stepping up the voltage for delivery through submarine high voltage cables. The cost of such cables increases with the distance from shore. Alternatives to the high cost of submarine cables are currently being contemplated. As in the case of land-based windplants with distant markets, there will be greatly increased costs as the offshore windpower facility moves farther from the shore and the load centers. In fact, the increase in costs over longer distance may be expected to be significantly higher in the case of offshore windplants. It would thus be advisable to develop alternative technologies allowing for the transmission of distant offshore energy such as produced by windpower.

A need exists, for example, to provide improved methods of delivering renewable energy credits with wind energy systems. There is a further need for creating renewable energy credits from wind energy systems that have direct compression wind turbine stations.

### SUMMARY

Accordingly, an object of the present invention is to provide methods for creating renewable energy credits from wind energy systems.

Another object of the present invention is to provide methods for creating renewable energy credits from wind energy systems that have direct compression wind turbine stations.

These and other objects of the present invention are achieved in a method of creating renewable energy credits from a wind energy system. A wind energy system is provided with a plurality of direct compression wind turbine stations. Direct compression is direct rotational motion of a shaft or a rotor coupled to one or more compressors. Wind energy is collected and stored from the plurality of direct compression wind turbine stations. Storage of the wind energy and the thermal energy system are used to create renewable energy credits.

### BRIEF DESCRIPTION OF THE DRAWINGS

FIG. 1(a) illustrates one embodiment of a wind energy and storage system of the present invention.

FIG. 1(b) illustrates one embodiment of a wind energy and storage system of the present invention with a multi-stage compressor

FIG. 2 illustrates one embodiment of a toroidal intersecting vane compressor that can be used with the present invention.

### DETAILED DESCRIPTION

In one embodiment of the present invention, a method of creating renewable energy credits from a wind energy system has a plurality of direct compression wind turbine stations. Direct compression is direct rotational motion of a shaft or a rotor coupled to one or more compressors. Wind energy is collected and stored from the plurality of direct compression wind turbine stations. Storage of the wind energy and the thermal energy system are used to create renewable energy credits. The renewable energy credits can have a value associated with a location of the wind energy system.

The wind energy system can be coupled to a thermal energy system and the wind energy and thermal energy from the thermal energy system is collected and stored. The renewable energy credits can be among the following: sulfur dioxide credits, nitrous oxide (NOX) credits, mercury reduction credits, cap and trade pollution credits, renewable obligation certificate (ROCs) credits, renewable energy credits (RECs), carbon credits, green energy credits, CO₂ credits, financially valuable environmental attributes, power purchase agreements and the like.

In various embodiments, the wind energy is stored as compressed air, liquefied air, other compresses or liquefied fluids, and as thermal energy. A variety of type of compressors can be utilized including but not limited to, reciprocating, rotary, roots-blower, single screw, twin screw, diaphragm, intersecting vein machine, torroidal intersecting vein machine and the like. An energy storage system is provided that is configured to use cold air from a turbo-expander for cooling and/or refrigeration purposes at the location.

The thermal energy system can be selected from, biomass, geothermal, solar, coal, natural gas, oil, industrial process heat, nuclear, heat from a chemical or manufacturing process, a wind compressor intercooler, a body of water and the like. At least a portion of the wind power can be used convert at least a portion of the thermal energy to electricity to increase efficiency of conversion. The thermal portion of the wind energy can be stored, managed, and enhanced by a solar thermal collector, thermal inertial mass, thin walled tubing with anti-freeze distributed inside the tank, fossil fuel burner, a circulation device for using hot air, and the like.

In one embodiment, at least a portion of the wind energy is expanded through an expander to make electricity. Thermal energy can be added to the expander in at least one of the following places: into an interior of the expander, at an intake to the expander, and at an outflow of the expander. The thermal energy added to the expander can be from dry air, humid air, wet steam, dry steam, and the like, or from any other fluid or medium that can exchange heat with the expander system.

An expander can be provided to expand at least a portion of the wind energy and at least a portion of the thermal energy from the thermal energy system. Suitable expanders include but are not limited to, reciprocating, rotary, roots-blower, single screw, twin screw, or diaphragm expander, natural gas turbine, intersecting vein machine, torroidal intersecting vein machine and the like. The expander is coupled to at least a portion of the plurality of direct compression wind turbine stations to produce electricity. The expander is coupled to a generator, wherein rotational energy of the expander is an input to a generator to make the electricity. In one embodiment, at least a portion of the energy from the wind energy system and the thermal energy system is dispatchable.

At least a portion of the electricity is available for sale to a wholesale or retail customer or on the open market. The renewable energy credits can be associated with the electricity produced, associated with electricity produced from the wind energy system and the thermal energy system and the like. In one embodiment, the renewable energy credits are associated with a value placed on the produced electricity.

In one embodiment, green credits are provided for the production of electricity from the wind energy system alone or in combination with the thermal energy system. The renewable energy credits attributed to wind power can receive green energy credit. In another embodiment, those renewable energy credits attributed to the thermal energy system, with attributes that qualify them as green energy credits, such as but not limited to thermal inputs derived from biomass combustion or gasification, also receive green energy credits. In one embodiment, a green energy credit of the thermal energy is increased in response to utilizing the wind power to covert the thermal energy into electricity.

All or a portion of the renewable energy credits can be sold to third parties. The sale to third parties can occur through a variety of mechanisms, including but not limited to, through a broker, a sales organization, an auction, directly from the wind energy system owner or manager, from a contracted owner of the renewable energy credit and the like.

The delivery of wind energy can be coordinated and stabilized. An energy delivery schedule can be created from the wind energy system in response to predictions for wind speed, wind power availability levels, historical, current and anticipated power and green energy prices, and historical, current and anticipated transmission availability. The delivery schedule can be used to match a customer's anticipated demand. The delivery schedule can manage updates and corrections to schedules on very short notice. The delivery schedule can be used to set a reduced number of constant power output periods during an upcoming period of time. By way of illustration, during the upcoming period of time energy, delivery levels can remain substantially constant despite fluctuations and oscillations in wind speed and wind power availability levels.

The upcoming period of time can be any period of time, including but not limited to the next 24 hour period. In one embodiment, no more than seven constant power output periods during any given 24 hour period, and the like.

The delivery schedule can take into account the amount of energy that can be supplied directly from the wind power system as well as stored energy. In one embodiment, the delivery schedule is utilized to determine an amount of energy that can be provided from storage, and an amount of power expected to be used and withdrawn by a power grid. In another embodiment, the delivery schedule is utilized to assist in ensuring that wind energy is available at constant power output levels even when the wind energy availability levels drop below a demand for power needed by a power grid.

In another embodiment, at least one demand history is created for a location to help forecast and predict how much energy will be used at the location during an upcoming period of time. Energy availability from the wind energy system can be determined. The demand history can be used for delivery of wind energy to the location to manage load, offset spikes, sags, and surges, and meet the needs of the grid and the customer.

The wind energy system can be coupled to a power grid that can be accessed to supply energy into storage by using electricity to run the generator/expanders backwards as motor/compressors to pressurize the system, which will then be expanded on demand to make electricity. An energy usage schedule can be developed using forecasts and predictions to for the upcoming time period to determine how energy from storage should be used to achieve a desired cost savings. A demand charge can be determined that may be applied based on spikes or surges that can occur during the upcoming time period, and an energy usage schedule then developed to reduce and/or offset the spikes or surges in a manner that achieves cost savings at a location. The location can be a commercial property end-user of energy and storage of energy is used to lower overall costs of energy at the commercial property end-use, and the like.

In one embodiment, an estimated cost savings for the upcoming time period is determined, and then that determination is repeated for an extended period of time, to help determine an overall cost savings that can be achieved during the extended period of time.

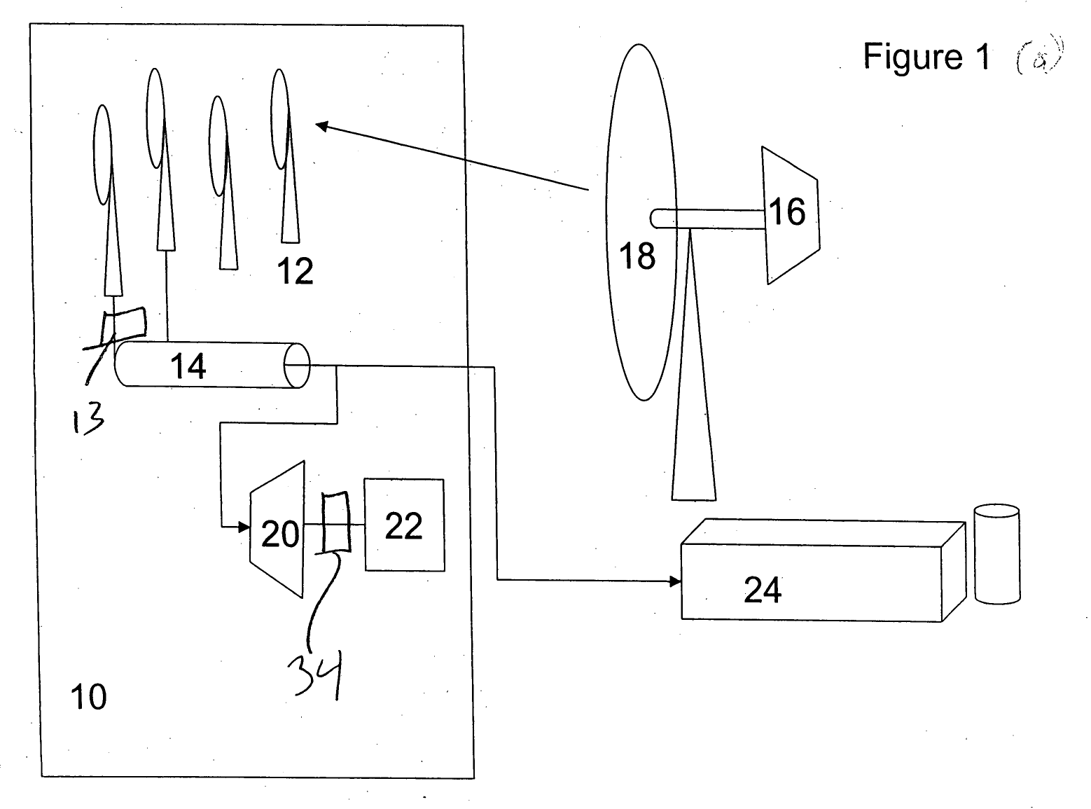

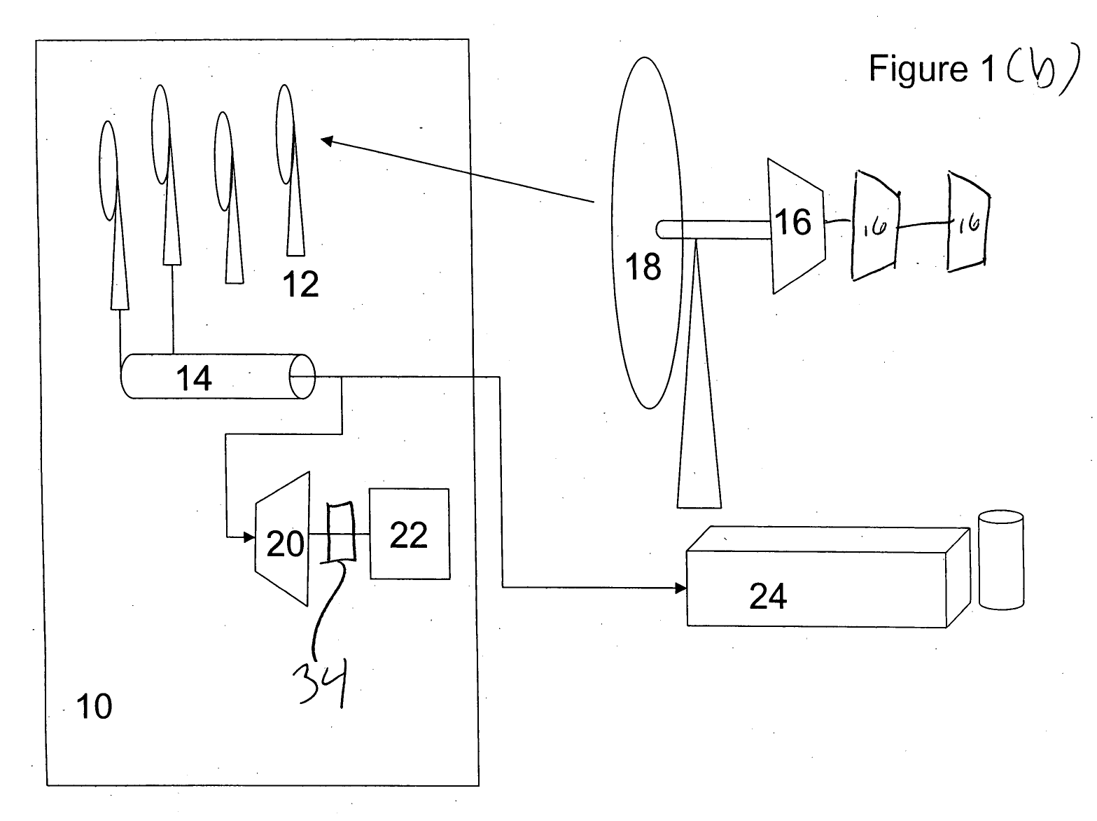

Referring to FIG. 1(a), one embodiment of the present invention is a wind energy generating and storage system, generally denoted as 10. A plurality of direct compression wind turbine stations 12 are provided. An intercooler 13 can be included. Direct compression is direct rotational motion of a shaft or a rotor coupled to one or more compressors 16. A storage device 14 is coupled to at least a portion of the wind turbine stations 12. At least a first toroidal intersecting vane compressor 16 is coupled to the storage device to compress or liquefy air. The compressor 16 has a fluid intake opening and a fluid exhaust opening. Rotation of a turbine 18 drives the compressor 16. At least one expander 20 is configured to release compressed or liquid air from the storage device 14. A generator 22 is configured to convert the compressed or liquid air energy into electrical energy.

In various embodiments, the compressor 16 operates at a pressure of about, 10 to 100 atmospheres at the fluid exhaust opening, 20 to 100 atmospheres, 10 to 80 atmospheres and the like. In various embodiments, the compressor has a minimum operating pressure for power storage of at least 20 atmospheres, has a peak pressure to low pressure ratio of about 10/1, has a peak pressure to low pressure ratio of about 5/1 and the like.

In one embodiment the system 10 has a power to weight ratio greater than 1 megawatt/15 tons. The compressor 16 is much lighter, and therefore less expensive than the generator 22 and gearbox it replaces. The best power-to-weight machine in current widescale commercial use is the Vestas 3 MW machine, which has a nacelle weight of 64 tons.

In another embodiment, illustrated in FIG. 1(b), a first multi-stage compressor 16 is coupled to the storage device 14 to compress air. In another embodiment, a pressure of compressed air in the storage device 14 is greater than 8 barr. The cost efficiency of storing compressed air in pipe changes dramatically with high pressure pipe and high pressure compressors 16. For relatively little extra cost, storage can increase an order of magnitude. 80 barr air holds ten times the energy storage of 8 barr air.

In one embodiment of the present invention, a method of production collects and stores wind energy from a plurality of direct compression wind turbine stations 12. Air is compressed or liquefied air is formed from the wind energy utilizing a toroidal intersecting vane compressor 16. An expander 20 is used to release compressed or liquid air. An absorber is introduced to the compressed or liquid air for pressure swing absorption. The absorber is used for air separation into oxygen or nitrogen, argon, and other air products. In one embodiment, the absorber absorbs at a higher pressure and desorbs at a lower pressure.

In one embodiment, at least a portion of the electrical energy, vacuum pressure, compressed air, heat from compression and liquid air or another compressed fluid from the system 10 is dispatchable to a production facility 24.

Suitable production facilities 24 include but are not limited to, an aluminum production facility, a fertilizer, ammonia, or urea production facility, a liquid air product production facility that can be used in manufacturing liquid air, liquid oxygen, liquid nitrogen, and other liquid air products, a fresh water from desalination production facility, a ferrosilicon production facility, an electricity intensive chemical process or manufacturing facility, a tire recycling plant, coal burning facility, biomass burning facility, medical facility, cryogenic cooling process, or any plant that gasifies liquid oxygen, nitrogen, argon, CO₂, an ethanol production facility, a food processing facility. Examples of food processing facilities include but are not limited to, dairy or meat processing facilities and the like

In one embodiment, electricity provided by the system 10 is used to electrolyze water at the production facility 24. In another embodiment, the system 10 is configured to provide pressure used at the production facility 24 to drive a reverse or forward osmosis process. In another embodiment, the system 10 is configured to provide at least one of vacuum or heat to drive a distillation process at the production facility 24. In one embodiment, the compressor 16 compresses fluid that is evaporating from fluid in a distillation process. In another embodiment, compressed fluid that is evaporating from a distillation process is returned to exchange its heat with liquid in an evaporation or distillation process

The production or processing facility 24 can be co-located with the system 10.

In one embodiment, the system 10 is configured to receive waste heat from the production facility 24 and utilize at least a portion of the waste heat to provide the electrical energy that is dispatched to the production facility 24. By way of illustration, and without limitation, the system 10 provides electricity for the reduction of carbon dioxide or water and can pressurize carbon dioxide to provide power to electrolyze the carbon dioxide to separate carbon from oxygen. The system 10 can be used to pressurize carbon dioxide and water to a supercritical state and provide power for reaction of these components to methanol. Hydrogen can be introduced to the carbon to create hydrocarbon fuels. The oxygen can be utilized to oxy-fire coal, process iron ore, burn col, process iron ore and the like.

The system 10 can be used to provide a vacuum directly to the production facility 24. This could assist, for example, in the production of products at low temperature distillation facilities, such as fresh water at desalination plants.

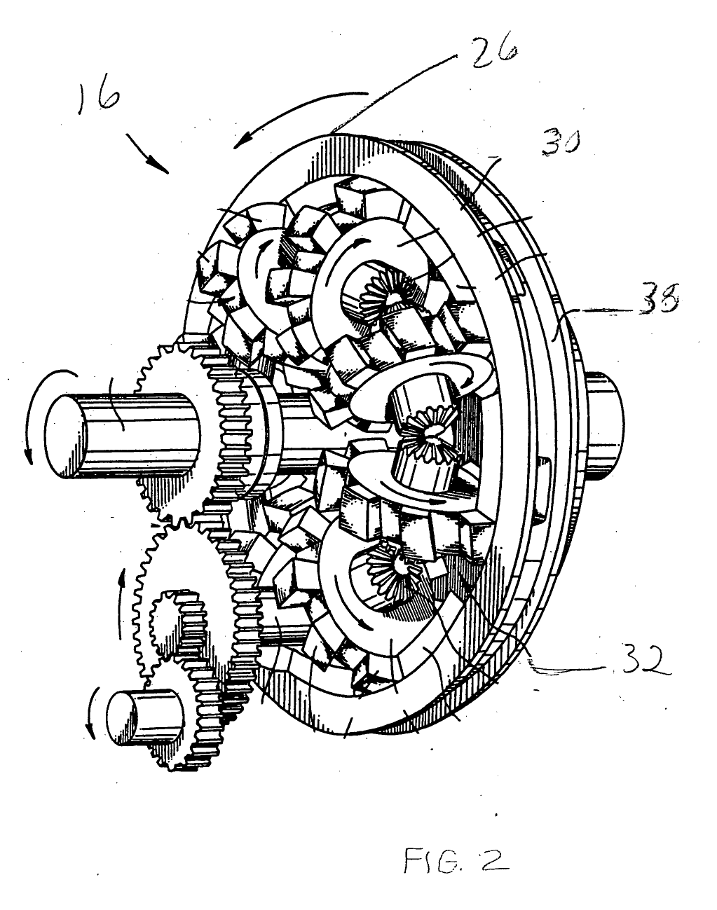

By way of illustration, and without limitation, as shown in FIG. 2 the toroidal intersecting vane compressor 16 includes a supporting structure 26, a first and second intersecting rotors 28 and 30 rotatably mounted in the supporting structure 26. The first rotor 28 has a plurality of primary vanes positioned in spaced relationship on a radially inner peripheral surface of the first rotor 28. The radially inner peripheral surface of the first rotor 28 and a radially inner peripheral surface of each of the primary vanes can be transversely concave, with spaces between the primary vanes and the inside surface to define a plurality of primary chambers 32. The second rotor 30 has a plurality of secondary vanes positioned in spaced relationship on a radially outer peripheral surface of the second rotor. The radially outer peripheral surface of the second rotor 30 and a radially outer peripheral surface of each of the secondary vanes can be transversely convex. Spaces between the secondary vanes and the inside surface define a plurality of secondary chambers 32. A first axis of rotation of the first rotor 28 and a second axis of rotation of the second rotor 30 are arranged so that the axes of rotation do not intersect. The first rotor 28, second rotor 30, primary vanes and secondary vanes are arranged so that the primary vanes and the secondary vanes intersect at only one location during their rotation. The toroidal intersecting vane compressor 16 can be self-synchronizing.

In one embodiment, the turbine 18 is configured to power the compressor(s) 16. For example, the turbine 18 can drive the compressor 16 by a friction wheel drive that is frictionally connected to the turbine 18 and is connected by a belt, a chain, or directly to a drive shaft or gear of the compressor 16. The compressed air can be heated or cooled. The compressed air can be heated or cooled while maintaining substantially constant volume. The compressed air can be heated or cooled while maintaining substantially constant pressure. The compressed air can be heated or cooled by a heat source selected from at least one of the following: solar, ocean, river, pond, lake, other sources of water, power plant effluent, industrial process effluent, combustion, nuclear, and geothermal energy.

The expander 20 can operate independently of the turbine 18 and the compressor 16. The expander 20 and compressor 16 can be approximately the same or different sizes.

A heat exchanger 34 can be provided and coupled to an expander exhaust opening. At least a portion of the compressed air energy can be used as a coolant.

In one specific embodiment, a rotatable turbine 18 is mounted to a mast. In one embodiment, as mentioned above, a toroidal intersecting vane compressor (TIVC) 16 is used. The TIVC is characterized by a fluid intake opening and a fluid exhaust opening, wherein the rotation of the turbine 18 drives the compressor 16. The system 10 permits good to excellent control over the hours of electrical power generation, thereby maximizing the commercial opportunity and meeting the public need during hours of high or peak usage. Additionally, the system 10 minimizes and can avoid the need to place an electrical generator 22 off-shore. The system 10 allows for an alternative method for transmission of power over long distance. Further, the system 10 can be operated with good to excellent efficiency rates.

In one embodiment, a generator apparatus 22 includes, (a) a rotatable turbine 18 mounted to a mast, (b) at least one toroidal intersecting vane compressor 16 characterized by a fluid intake opening and a fluid exhaust opening, wherein the rotation of the turbine 18 drives the compressor 16; (c) a conduit having a proximal end and a distal end wherein the proximal end is attached to the fluid exhaust opening; (d) at least one toroidal intersecting vane expander 20 characterized by a fluid intake opening attached to the distal end; (e) an electrical generator 22 operably attached to the expander 20 to convert rotational energy into electrical energy, and to connect the generator 22 to one or more customers or the electric grid to sell the electricity.

The turbine 18 can be powered to rotate by a number of means apparent to the person of skill in the art. One example is air flow, such as is created by wind. In this embodiment, the turbine 18 can be a wind turbine, such as those well known in the art. One example of a wind turbine is found in U.S. Pat. No. 6,270,308, which is incorporated herein by reference. Because wind velocities are particularly reliable off shore, the turbine 18 can be configured to stand or float off shore, as is known in the art. In yet another embodiment, the turbine 18 can be powered to rotate by water flow, such as is generated by a river or a dam.

As mentioned above, the compressor 16 is preferably a toroidal intersecting vane compressor 16, such as those described in Chomyszak U.S. Pat. No. 5,233,954, issued Aug. 10, 1993 and Tomcyzk, U.S. patent application Publication No. 2003/0111040, published Jun. 19, 2003. The contents of the patent and publication are incorporated herein by reference in their entirety. In a particularly preferred embodiment, the toroidal intersecting vane compressor 16 and elements of the system 10, are found in U.S. Publications Nos. 2005132999, 2005133000 and 20055232801, each incorporated herein fully by reference.

In one embodiment, two or more toroidal intersecting vane compressors 16 are utilized. The compressors 16 can be configured in series or in parallel and/or can each be single stage or multistage compressors 16. The compressor 16 will generally compress air, however, other environments or applications may allow other compressible fluids to be used.

The air exiting the compressor 16 through the compressor exhaust opening will directly or indirectly fill a conduit. Multiple turbines 18, and their associated compressors 16, can fill the same or different conduits. For example, a single conduit can receive the compressed air from an entire wind turbine farm, windplant or windpower facility. Alternatively or additionally, the “wind turbine farm” or, the turbines 18 therein, can fill multiple conduits. The conduit(s) can be used to collect, store, and/or transmit the compressed fluid, or air. Depending upon the volume of the conduit, large volumes of compressed air can be stored and transmitted. The conduit can direct the air flow to a storage vessel or tank or directly to the expander 20. The conduit is preferably made of a material that can withstand high pressures, such as those generated by the compressors 16. Further, the conduit should be manufactured out of a material appropriate to withstand the environmental stresses. For example, where the wind turbine 18 is located off shore, the conduit should be made of a material that will withstand seawater, such as pipelines that are used in the natural gas industry.

The compressed air can be heated or cooled in the conduit or in a slip, or side, stream off the conduit or in a storage vessel or tank. Cooling the fluid can have advantages in multi-stage compressing. Heating the fluid can have the advantage of increasing the energy stored within the fluid, prior to subjecting it to an expander 20. The compressed air can be subjected to a constant volume or constant pressure heating or cooling. The source of heating can be passive or active. For example, sources of heat include solar, ocean, river, pond, lake, other sources of water, power plant effluent, industrial process effluent, combustion, nuclear, and geothermal energy. The conduit, or compressed air, can be passed through a heat exchanger to cool waste heat, such as can be found in power plant streams and effluents and industrial process streams and effluents (e.g., liquid and gas waste streams). In yet another embodiment, the compressed air can be heated via combustion.

Like the TIVC, the expander 20 is preferably a toroidal intersecting vane expander 20 (TIVE), such as those described by Chomyszak, referenced above. Thus, the toroidal intersecting vane expander 20 can comprise a supporting structure, a first and second intersecting rotors rotatably mounted in the supporting structure, the first rotor having a plurality of primary vanes positioned in spaced relationship on a radially inner peripheral surface of the first rotor with the radially inner peripheral surface of the first rotor and a radially inner peripheral surface of each of the primary vanes being transversely concave, with spaces between the primary vanes and the inside surface defining a plurality of primary chambers, the second rotor having a plurality of secondary vanes positioned in spaced relationship on a radially outer peripheral surface of the second rotor with the radially outer peripheral surface of the second rotor and a radially outer peripheral surface of each of the secondary vanes being transversely convex, with spaces between the secondary vanes and the inside surface defining a plurality of secondary chambers, with a first axis of rotation of the first rotor and a second axis of rotation of the second rotor arranged so that the axes of rotation do not intersect, the first rotor, the second rotor, primary vanes and secondary vanes being arranged so that the primary vanes and the secondary vanes intersect at only one location during their rotation. Similarly, the toroidal intersecting vane expander 20 is self-synchronizing. Like the TIVC, the expanders 20 can be multistage or single stage, used alone, in series or in parallel with additional TIVEs. A single TIVE can service a single conduit or multiple conduits.

One of the advantages of the present invention is the ability to collect the compressed air or other fluid and convert the compressed air or fluid to electricity independently of each other. As such, the electricity generation can be accomplished at a different time and in a shorter, or longer, time period, as desired, such as during periods of high power demand or when the price of the energy is at its highest.

As such, the expander 20 is preferably configured to operate independently of the turbine 18 and compressor 16. Further, because the conduit that is directing the compressed fluid, or air, to the expander 20 can be of a very large volume, the expander 20 need not be located proximally with the turbine 18 and compressor 16. As such, even where the wind turbine 18 is located off shore, the expander 20 can be located on land, such as at a power plant, thereby avoiding the need to transmit electricity from the wind farm to the grid or customer.

Further, the sizes and capacities of the TIVCs and TIVEs can be approximately the same or different. The capacity of the TIVE is preferably at least 0.5 times the capacity of the TIVCs it services, preferably the capacity of the TIVE exceeds the capacity of the TIVCs it services. Generally, the capacity of the TIVE is between about 1 and 5 times the capacity of the TIVCs it serves. For example, if 100 turbines 18, with 100 TIVCs, each have a capacity of 2 megawatts, a TIVE that services all 100 turbines 18, preferably has the capacity to produce 100 megawatts, preferably at least about 200 to 1,000 megawatts. Of course, TIVEs and TIVCs of a wide range of capacities can be designed.

Additional modifications to further improve energy usage can be envisioned from the apparatus of the invention. Energy recycle streams and strategies can be easily incorporated into the apparatus. For example, the expanded fluid exiting from the expander 20 will generally be cold. This fluid can be efficiently used as a coolant, such as in a heat exchanger.

The dimensions and ranges herein are set forth solely for the purpose of illustrating typical device dimensions. The actual dimensions of a device constructed according to the principles of the present invention may obviously vary outside of the listed ranges without departing from those basic principles.

Further, it should be apparent to those skilled in the art that various changes in form and details of the invention as shown and described may be made. It is intended that such changes be included within the spirit and scope of the claims appended hereto.

1. A method of creating renewable energy credits from a wind energy system, comprising:
providing a wind energy system with a plurality of direct compression wind turbine stations, wherein direct compression is direct rotational motion of a shaft or a rotor coupled to one or more compressors;
collecting and storing wind energy from the plurality of direct compression wind turbine stations; and
utilizing the storage of the wind energy and the thermal energy system to create renewable energy credits.

2. The method of claim 1, further comprising:
operating a compressor at a pressure of 10 to 100 atmospheres at a fluid exhaust opening.

3. The method of claim 1, further comprising:
operating a compressor at a pressure of about 10 to 80 atmospheres at a fluid exhaust opening.

4. The method of claim 1, further comprising:
operating a compressor at a pressure of about 20 to 100 atmospheres at a fluid exhaust opening.

5. The method of claim 1, further comprising:
operating a compressor with a minimum operating pressure for power storage of at least 20 atmospheres.

6. The method of claim 1, further comprising:
operating a compressor that has a peak pressure to low pressure ratio of about 10/1.

7. The method of claim 1, further comprising:
operating a compressor that has a peak pressure to low pressure ratio of about 5/1.

8. The method of claim 1, wherein the wind energy system is coupled to a thermal energy system and the wind energy and thermal energy from the thermal energy system is collected and stored.

9. The method of claim 1, wherein the renewable energy credits are selected from, sulfur dioxide credits, nitrous oxide (NOX) credits, mercury reduction credits, cap and trade pollution credits, renewable obligation certificate (ROCs) credits, renewable energy credits (RECs), carbon credits, green energy credits, CO₂ credits, fipancially valuable environmental attributes, and power purchase agreements.

10. The method of claim 1, wherein the wind energy is stored as compressed air, liquefied air, or a compressed or liquefied fluid, and as thermal energy.

11. The method of claim 1, wherein the compressors are selected from, reciprocating, rotary, roots-blower, single screw, twin screw, diaphragm, intersecting vein machine and torroidal intersecting vein machine.

12. The method of claim 1, wherein the thermal energy system is selected from at least one of a, biomass, geothermal, solar, coal, natural gas, oil, industrial process heat, nuclear, heat from a chemical or manufacturing process, a wind compressor intercooler and any body or source of water.

13. The method of claim 1, further comprising:
expanding at least a portion of the wind energy through an expander and making electricity.

14. The method of claim 19, wherein thermal energy is added to the expander in at least one of the following places, into an interior of the expander, at an intake to the expander, and at an outflow of the expander.

15. The method of claim 20, wherein the thermal energy added to the expander is selected from dry air, humid air, wet steam, dry steam, or any other fluid that can act as a heat transfer agent.

16. The method of claim 8, wherein an expander is provided to expand at least a portion of the wind energy and at least a portion of thermal energy from the thermal energy system.

17. The method of claim 19, wherein the expander is selected from a reciprocating, rotary, roots-blower, single screw, twin screw, or diaphragm expander, natural gas turbine, intersecting vein machine and toroidal intersecting vein machine.

18. The method of claim 19, wherein the expander is coupled to at least a portion of the plurality of direct compression wind turbine stations to produce electricity.

19. The method of claim 18, further comprising:
producing electricity for a wholesale or retail customer or the open market.

20. The method of claim 19, wherein the expander is coupled to a generator, wherein rotational energy of the expander is an input to a generator to make the electricity.

21. The method of claim 20, wherein at least a portion of the electricity is available for sale to a wholesale or retail customer or on the open market.

22. The method of claim 19, wherein the renewable energy credits are associated with the electricity produced.

23. The method of claim 8, wherein the renewable energy credits are associated with electricity produced from the wind energy system and the thermal energy system.

24. The method of claim 1 wherein green credits are provided for the production of electricity from the wind energy system.

25. The method of claim 1, wherein green credits are provided for the production of electricity from the wind energy system and at least a portion of energy from the thermal energy system.

26. The method of claim 1, wherein at least a portion of the energy from the wind energy system and the thermal energy system is dispatchable.

27. The method of claim 19, wherein the renewable energy credits have a value associated with a location of the wind energy system.

28. The method of claim 19, wherein the renewable energy credits are associated with a value placed on the produced electricity.

29. The method of claim 19, wherein the renewable energy credits are sold to third parties through a broker, a sales organization, an auction, directly from the wind energy system owner or manager, and from a contracted owner of the renewable energy credit.

30. The method of claim 8, wherein the renewable energy credits attributed to wind power receive green energy credit.

31. The method of claim 21, wherein those renewable energy credits attributed to the thermal energy system that have attributes which qualify them as green energy credits, also receive green energy credits.

32. The method of claim 8, further comprising:
utilizing at least a portion of the wind power to convert at least a portion of the thermal energy to electricity to increase efficiency of conversion.

33. The method of claim 21, wherein a green energy credit of the thermal energy is increased in response to utilizing the wind power to covert the thermal energy into electricity.

34. The method of claim 1, further comprising:
coordinating and stabilizing the delivery of wind energy.

35. The method of claim 1, further comprising:
creating an energy delivery schedule from the wind energy system in response to predictions for wind speed and wind power availability levels.

36. The method of claim 41, further comprising:
using the delivery schedule to meet customer demands, or to set a reduced number of constant power output periods during an upcoming period of time.

37. The method of claim 36, wherein during the upcoming period of time energy delivery levels can remain substantially constant despite fluctuations and oscillations in wind speed and wind power availability levels.

38. The method of claim 36, wherein the upcoming period of time is the next 24-hour period.

39. The method of claim 44, further comprising:
setting no more than seven constant power output periods during any given 24 hour period.

40. The method of claim 41, wherein the delivery schedule takes into account the amount of energy that can be supplied directly from the wind power system as well as stored energy.

41. The method of claim 41, wherein the delivery schedule is utilized to determine an amount of energy that can be provided from storage, and an amount of power expected to be used and withdrawn by a power grid.

42. The method of claim 41, wherein the delivery schedule is utilized to assist in ensuring that wind energy is available at constant power output levels even when the wind energy availability levels drop below a demand for power needed by a power grid.

43. The method of claim 1, further comprising:
creating at least one demand history for a location to help forecast and predict how much energy will be used at the location during an upcoming period of time.

44. The method of claim 43, further comprising:
determining when energy will be available from the wind energy system.

45. The method of claim 44, further comprising:
using the demand history for delivery of wind energy to the location.

46. The method of claim 41, further comprising:
using the demand history for delivery of wind energy to the location to offset spikes, surges, or sags at the location.

47. The method of claim 1, further comprising:
creating an energy delivery schedule in response to predictions for at least one of, wind speed, wind power availability levels, historical power levels or prices, current power levels or prices, anticipated power levels or prices, green energy prices, historical transmission availability, current transmission availability and anticipated transmission availability.

48. The method of claim 47, wherein the delivery schedule can be used to match a customer's anticipated demand.

49. The method of claim 47, wherein the delivery schedule can manage updates and corrections to schedules on a short notice.

50. The method of claim 43, wherein the wind energy system is coupled to a power grid that can be accessed to supply energy into storage by using electricity to run compressors to pressurize the system, which will then be expanded on demand to make electricity.

51. The method of claim 1, further comprising:
using forecasts and predictions to develop an energy usage schedule for the upcoming time period to determine how energy from storage should be used to achieve a desired cost savings.

52. The method of claim 43, further comprising:
determining a demand charge that may be applied based on spikes or surges that can occur during the upcoming time period and developing an energy usage schedule to reduce and/or offset the spikes or surges in a manner that achieves cost savings.

53. The method of claim 43, wherein the location is a commercial property end-user of energy and storage of energy is used to lower overall costs of energy at the commercial property end-use.

54. The method of claim 43, wherein an estimated cost savings for the upcoming time period is determined, and then that determination is repeated for an extended period of time, to help determine an overall cost savings that can be achieved during the extended period of time.

55. The method of claim 43, wherein the thermal portion of the wind energy can be stored, managed, and enhanced by at least one of, a solar thermal collector, thermal inertial mass, thin walled tubing with antifreeze distributed inside the tank, fossil fuel burner and a circulation device for using hot air.

56. The method of claim 43, wherein an energy storage system is provided that is configured to use cold air from a turbo-expander for cooling and/or refrigeration purposes at the location.
